(19) United States
(12) Patent Application Publication
(10) Pub. No.: US 2015/0054763 A1
(43) Pub. Date: Feb. 26, 2015

(54) DRIVING CIRCUIT HAVING NOISE IMMUNITY

(71) Applicant: Raydium Semiconductor Corporation, Hsinchu (TW)

(72) Inventors: Chun-Wei YANG, Kaohsiung City (TW); Chih YUAN, New Taipei City (TW)

(21) Appl. No.: 14/459,902

(22) Filed: Aug. 14, 2014

(30) Foreign Application Priority Data
Aug. 20, 2013 (TW) 102129847

(51) Int. Cl. G06F 3/041

(52) U.S. Cl. CPC G06F 3/0418
USPC 345/173

(57) ABSTRACT

A driving circuit including a display module, a retrieving module, a touch module, and an adjusting module is provided. The display module outputs a plurality of image control signals. The retrieving module is coupled with the display module, wherein the retrieving module retrieves the image control signals and sets a preset offset value according to a coupling level of the image control signals. The touch module outputs a plurality of driving signals. The adjusting module is coupled between the retrieving module and the touch module, wherein the adjusting module adjusts the driving signals according to the preset offset value.

### BACKGROUND OF THE INVENTION

1. Field of the Invention

This invention relates to a driving circuit having noise immunity, especially to an embedded touch display driving circuit having a compensation mechanism to reduce noise.

2. Description of the Related Art

In recent years, with the progress of technology, touch display panels have been widely used in various touch display apparatus, such as tablet PC, smart phone, industrial PC, ATM, digital camera. In general, the touch display panel including a display panel and a touch panel can provide functions of displaying images and sensing touch points. In practical applications, the display panel and the touch panel are integrated to form an in-cell touch display panel having reduced thickness.

However, because the touch panel is directly embedded into the display panel, the operation of the touch panel will be interfered by the display signals on the display panel. For example, the display panel receives a display control signal from chip, but the display control signal is easily coupled with the sensing voltage on the touch panel. In other words, the sensing voltage on the touch panel is easily interfered by the display control signal.

In fact, the touch panel uses the driving voltage to control the sensing voltage. However, under the interference of the display panel, even the driving voltage is kept stable, the voltages sensed by the touch panel are still different. In this condition, touch point misjudgment will be occurred on the touch panel, and the touch sensing performance of the touch display panel will become poor. It is necessary to design a touch display driving circuit capable of reducing noise and enhancing touch sensing performance.

### SUMMARY OF THE INVENTION

Therefore, the invention provides to a driving circuit having a compensation mechanism to reduce noise to solve the above-mentioned problems.

A scope of the invention is to provide a driving circuit capable of retrieving display signals to set compensation values.

Another scope of the invention is to provide a driving circuit having a look-up table to resist to noise.

Another scope of the invention is to provide a driving circuit capable of compensating touch signals to enhance touch sensing accuracy.

An embodiment of the invention is a driving circuit. In this embodiment, the driving circuit includes a display module, a retrieving module, a touch module, and an adjusting module. The display module outputs a plurality of image control signals. The retrieving module is coupled with the display module, wherein the retrieving module retrieves the image control signals and sets a preset offset value according to a coupling level of the image control signals. The touch module outputs a plurality of driving signals. The adjusting module is coupled between the retrieving module and the touch module, wherein the adjusting module adjusts the driving signals according to the preset offset value.

In an embodiment, the plurality of image control signals includes a plurality of common electrode signals, the retrieving module calculates a coupling offset related to the plurality of common electrode signals to set the preset offset value.

In an embodiment, the coupling offset is formed by the plurality of common electrode signals coupling with some of the plurality of image control signals other than the plurality of common electrode signals.

In an embodiment, the driving circuit further includes an operation module having a look-up table. The look-up table includes the relationship between the preset offset value and the plurality of common electrode signals and the adjusting module adjusts the plurality of driving signals according to the look-up table.

In an embodiment, changes of the preset offset value and the coupling offset are inverted.

In an embodiment, the adjusting module superimposes the preset offset value to the plurality of driving signals in inverting phases to compensate the plurality of driving signals, and the touch module generates a plurality of sensing signals according to the compensated driving signals.

In an embodiment, the driving circuit further includes a touch panel. The touch panel is coupled to the display module and the touch module and used for receiving the plurality of sensing signals from the touch module.

In an embodiment, each of the driving signals corresponds to a digital driving value respectively, and the digital driving values change with the compensated driving signals.

In an embodiment, the plurality of image control signals includes a plurality of data electrode signals and a plurality of polarity control signals, and the plurality of data electrode signals are source electrode control signals.

In an embodiment, when the adjusting module adjusts the plurality of driving signals according to the preset offset value, the plurality of driving signals is adjusted by an external voltage.

Compared to the prior art, the driving circuit of the invention uses the retrieving module to obtain the information of the image control signals and adjust the driving signal according to the coupling level of the image control signals. The retrieving module of the invention can calculate the coupling interference generated by the image control signals and provide a preset offset value. In addition, the driving circuit uses the adjusting module to adjust the voltage value of the driving signal to generate a correct sensing signal, so that the touch sensing accuracy of the touch display apparatus using the driving circuit will be enhanced.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic diagram of the driving circuit in an embodiment of the invention.

FIG. 2 illustrates schematic diagrams of the image signal and the touch sensing signal in the driving circuit.

FIG. 3 illustrates a schematic diagram of the driving circuit in another embodiment of the invention.

### DETAILED DESCRIPTION

A preferred embodiment of the invention is a driving circuit having noise immunity. In this embodiment, the driving circuit is disposed in a touch display apparatus, for example, an embedded touch display apparatus, but not limited to this.

In other words, the touch display apparatus is an in-cell touch panel. In the touch display apparatus, a touch module is integrated in a display panel structure, and the touch module can be a capacitive touch matrix, a resistive touch matrix, or an optical touch matrix. In this embodiment, the touch matrix is the capacitive touch matrix, but not limited to this. It should be noticed that the capacitive touch matrix has multi-touch function and can support two or more touch points. In addition, the embedded touch display apparatus can be a mobile phone, a digital camera, a tablet PC, a notebook, an industrial PC, a portable multi-media player, or a navigation apparatus, but not limited to this.

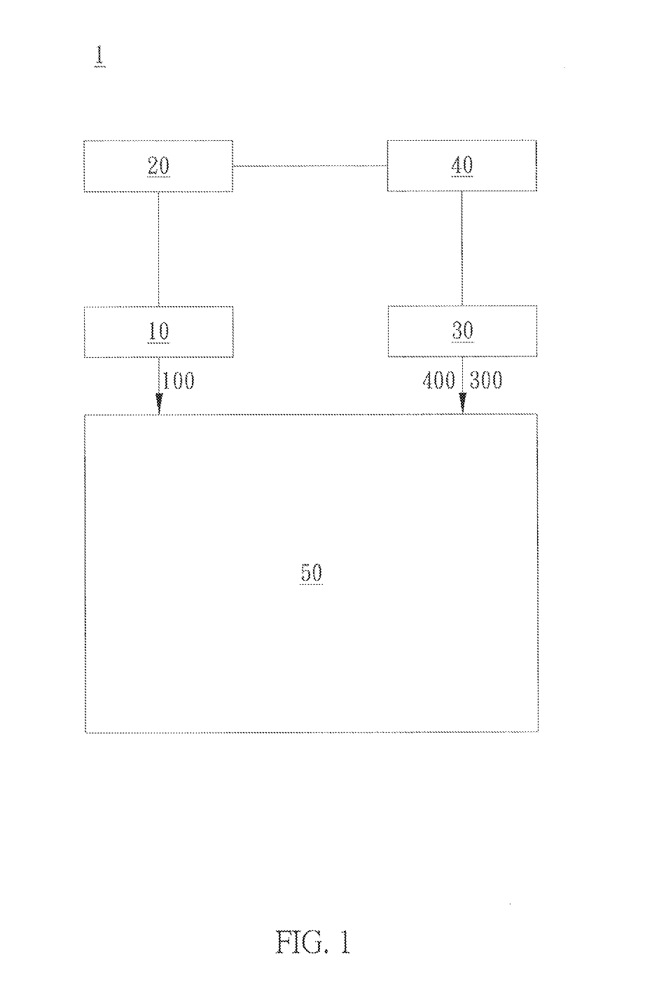

Please refer to FIG. 1. FIG. 1 illustrates a schematic diagram of the driving circuit in this embodiment. As shown in FIG. 1, the driving circuit 1 includes a display module 10, a retrieving module 20, a touch module 30, an adjusting module 40, and a touch display panel 50. In this embodiment, the retrieving module 20 is coupled to the display module 10; the adjusting module 40 is coupled between the retrieving module 20 and the touch module 30; the display module 10 and the touch module 30 are coupled to the touch display panel 50 respectively. It should be noticed that the touch display panel 50 is the in-cell touch panel capable of displaying images and supporting touch function.

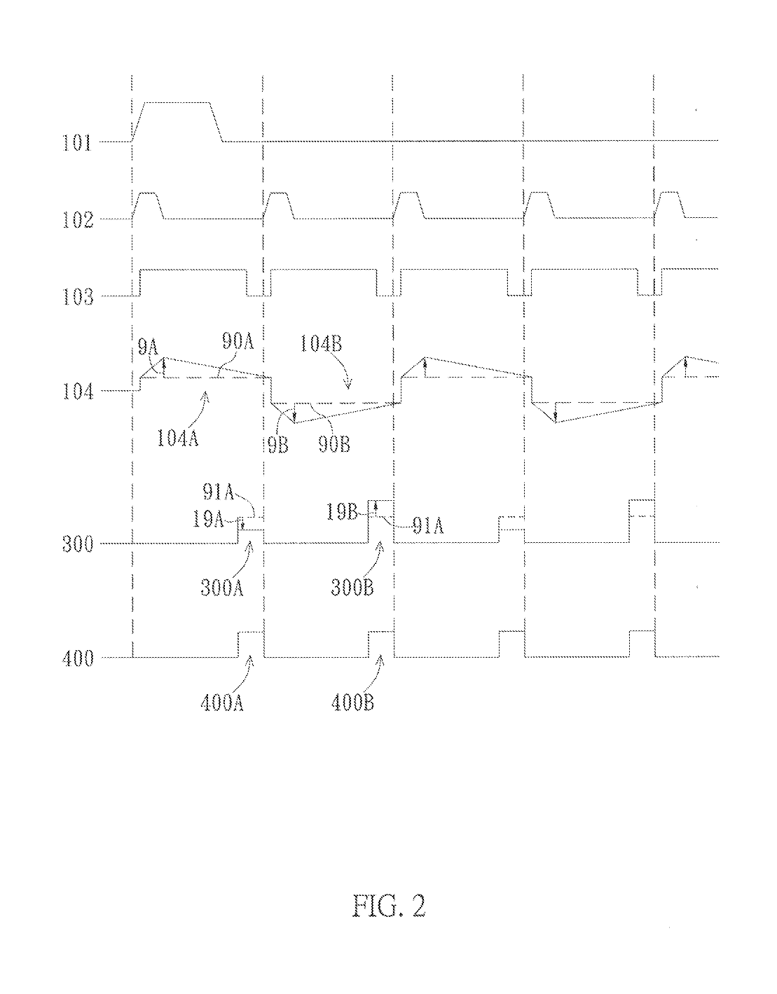

In this embodiment, the retrieving module 20 retrieves the plurality of image control signals 100 and sets a preset offset value according to a coupling level of the plurality of image control signals 100. Please refer to FIG. 2. FIG. 2 illustrates schematic diagrams of the image signal and the touch sensing signal in the driving circuit 1. It should be noticed that the plurality of image control signals 100 includes a vertical sync (VSYNC) signal 101, a horizontal sync (HSYNC) signal 102, a display signal 103, a plurality of data electrode signals (not shown in the figures), a plurality of polarity control signals (not shown in the figures), and a plurality of common electrode signals 104.

In practical applications, the VSYNC signal 101 is a start signal of each frame, and the HSYNC signal 102 is a start signal of each video line. The VSYNC signal 101 and the HSYNC signal 102 form a 2-D image matrix. The data electrode signal is a source electrode control signal and used to provide a data line voltage. The polarity control signal is used to control the polarity of the data line to be positive or negative and prevent the data line from being polarized. It should be noticed that the display module 10 outputs a plurality of image control signals 100 to the touch display panel 50, and the touch module 30 outputs a plurality of driving signals 300 to the touch display panel 50. The plurality of driving signals 300 includes different driving signals 300A and 300B during different periods of time. It should be noticed that the driving signals 300A and 300B are formed by raising or lowering a driving level 91A respectively.

It should be noticed that the common electrode signal 104 is a square-wave signal used to determine a liquid crystal flip voltage. However, as shown in FIG. 2, in practical applications, a part of other image control signals is coupled with the common electrode signals 104, so that the common electrode signals 104 will generate a coupling offset 9A/9B. It is easy that the common electrode signals 104 are interfered by the image control signals and the common electrode signals 104 will be changed from the square-wave signal to a coupled-wave signal. It should be noticed that the common electrode signals 104 are mainly interfered by the data electrode signals and the polarity control signals. In addition, since the path of the common electrode signals 104 is very near to the touch display panel 50, the interfered common electrode signals 104 will further affect the signals on the touch display panel 50.

As shown in FIG. 2, the amplitude of the common electrode signal 104A is originally located at a common electrode level 90A. However, the common electrode signal 104A are affected by the image control signals 100, so that the level of the common electrode signal 104A are raised the coupling offset 9A from the common electrode level 90A. It should be noticed that the retrieving module 20 sets the preset offset value 19A according to the coupling offset 9A that the common electrode signals 104A coupling with some of the other image control signals. The adjusting module 40 adjusts the driving signals 300A according to the preset offset value 19A. In practical applications, in the touch display panel 50, the common electrode signal 104A is mainly interfered by the data electrode signals and the polarity control signals, but not limited to this.

In addition, the retrieving module 20 can calculate the coupling offset 9A that the common electrode signals 104A coupling with some of the other image control signals in advance to set the preset offset value 19A. In practical applications, changes of the preset offset value 19A and the coupling offset 9A are inverted. In other words, when the coupling offset 9A is offset upward, the preset offset value 19A will be offset downward. It should be noticed that the driving circuit 1 of the invention can use the retrieving module 20 to calculate the degree that the common electrode signals 104 are interfered to adjust the driving signal 300 and further control the sensing signal 400 to enhance the touch sensing accuracy.

As shown in FIG. 2, the amplitude of the common electrode signal 104B is originally located at a common electrode level 90B. However, the common electrode signal 104B are coupled by the image control signals 100, so that the level of the common electrode signal 104B are lowered the coupling offset 9B from the common electrode level 90B. It should be noticed that the retrieving module 20 can calculate the coupling offset 9B that the common electrode signals 104B coupling with some of the other image control signals in advance to set the preset offset value 19B, wherein the preset offset value 19B are offset downward; or the retrieving module 20 can set the preset offset value 19B according the coupling offset 9B that the common electrode signals 104B coupling with some of the other image control signals.

It should be noticed that when the adjusting module 40 adjusts the plurality of driving signals according to the preset offset value 19A, the plurality of driving signals is adjusted by an external voltage. In fact, the adjusting module 40 is coupled to a power supply (not shown in the figures), and the power supply provides the external voltage to the adjusting module 40. The adjusting module 40 converts the external voltage into the preset offset value 19A to compensate the driving signals 300A.

In this embodiment, the adjusting module 40 superimposes the preset offset value to the plurality of driving signals 300 in inverting phases to compensate the plurality of driving signals 300, and the touch module 30 generates the plurality of sensing signals 400 according to the compensated driving signals 300. As shown in FIG. 2, taking the driving signal 300A for example, the driving signal 300A corresponds to the common electrode signals 104A and the coupling offset 9A, wherein the coupling offset 9A is a positive value, and the preset offset value 19A corresponding to the coupling offset 9A is superimposed to the driving signal 300A to complete the compensation. It should be noticed that the coupling offset 9A is a positive value and the preset offset value 19A is a negative value.

In addition, the touch module 30 generates the sensing signals 400 according to the driving signals 300, wherein the sensing signals 400A and 400B during different periods of time are located at the same level. It should be noticed that the driving circuit 1 determines whether the touch panel is touched according to the change of the sensing signals 400. Under the condition of no touch, the sensing signals 400 are all located at the same level. In practical applications, although the driving signals 300A are affected by the common electrode signals 104A having the coupling offset 9A, the touch module 30 uses the compensated driving signals 300A to replace the driving signals originally located at the driving level 91A, and the touch module 30 generates the sensing signals 400A according to the compensated driving signals 300A.

In general, the driving signals will be raised with the raising common electrode signals, and the sensing signals generated according to the driving signals will be also changed, some touch sensing errors will be occurred. However, in this embodiment, since the touch module 30 uses the compensated driving signals 300A to generate the sensing signals 400A, and the sensing signals 400A are generated according to the common electrode signals 104A and the compensated driving signals 300A at the same time, the sensing signals 400A will be located at original level.

On the other hand, taking the driving signal 300B for example, the driving signal 300B corresponds to the common electrode signals 104B and the coupling offset 9B, wherein the coupling offset 9B is a negative value, and the preset offset value 19B corresponding to the coupling offset 9B is superimposed to the driving signal 300B to complete the compensation. It should be noticed that the coupling offset 9B is a negative value and the preset offset value 19B is a positive value. In addition, the touch module 30 generates the sensing signals 400B according to the driving signals 300B, wherein the sensing signals 400A and 400B are located at the same level. In other words, the sensing signals 400B will not be affected by the common electrode signals 104B forming electrical coupling because the sensing signals 400B are generated according to the compensated driving signals 300B. In practical applications, although the driving signals 300B are affected by the common electrode signals 104B having the coupling offset 9B, the touch module 30 uses the compensated driving signals 300B to replace the driving signals originally located at the driving level 91A, and the touch module 30 generates the sensing signals 400B according to the compensated driving signals 300B.

In this embodiment, since the touch module 30 uses the compensated driving signals 300B to generate the sensing signals 400B, and the sensing signals 400B are generated according to the common electrode signals 104B and the compensated driving signals 300B at the same time, the sensing signals 400B will be located at original level.

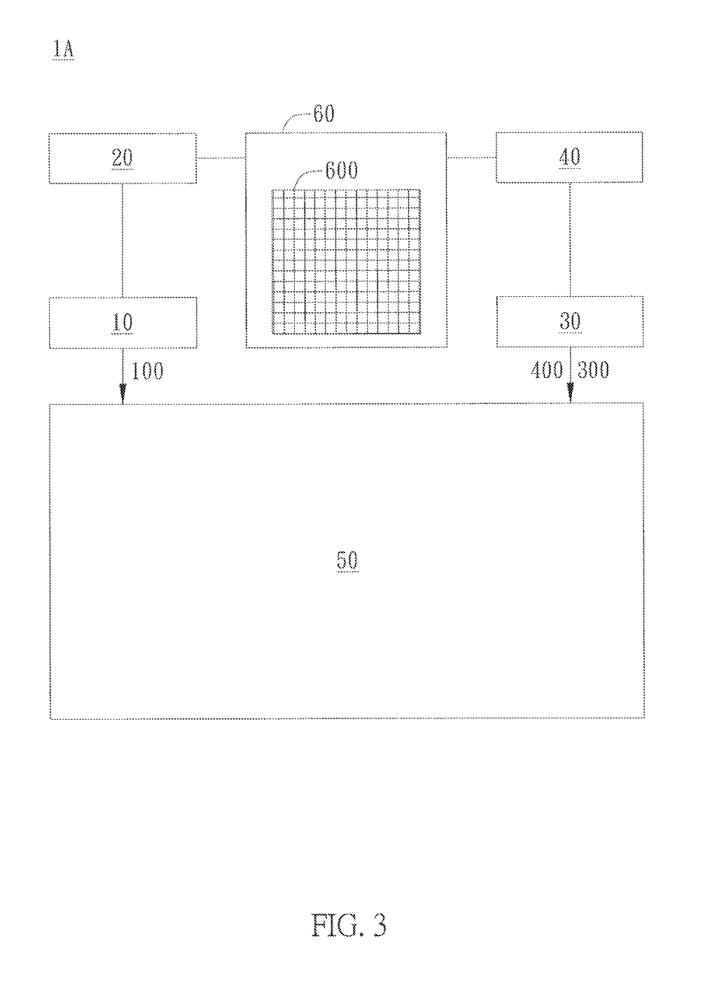

Please refer to FIG. 3. FIG. 3 illustrates a schematic diagram of the driving circuit in another embodiment of the invention. As shown in FIG. 3, the driving circuit 1A includes an operation module 60 having a look-up table 600. In this embodiment, the look-up table 600 includes the relationship between the preset offset value and the plurality of common electrode signals 104 and the adjusting module 40 adjusts the plurality of driving signals 300 according to the look-up table 600. It should be noticed that the retrieving module 20 can calculate the coupling offset that the common electrode signals 104 coupling with the image control signals in advance to set the preset offset value. In addition, since the common electrode signals 104 are known in the driving circuit 1A, the operation module 60 can establish the look-up table 600 according to the preset offset value and the common electrode signals 104, so that the adjusting module 40 can compensate the driving signals 300 according to the look-up table 600 to increase the touch sensing accuracy of the touch display panel 50.

It should be noticed that in the above-mentioned embodiments, analog voltages are used to compensate the driving signals to provide correct sensing signals. In practical applications, the driving circuit converts analog signals into digital signals. The driving signals correspond to digital driving values respectively, and the digital driving values are varied with the compensated driving signals. Since the digital driving values are compensated at the digital sections of the driving circuit, the driving circuit can also provide compensated digital driving values to generate correct sensing signals.

Compared to the prior art, the driving circuit of the invention uses the retrieving module to obtain the information of the image control signals and adjust the driving signal according to the coupling level of the image control signals. The retrieving module of the invention can calculate the coupling interference generated by the image control signals and provide a preset offset value. In addition, the driving circuit uses the adjusting module to adjust the voltage value of the driving signal to generate a correct sensing signal, so that the touch sensing accuracy of the touch display apparatus using the driving circuit will be enhanced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A driving circuit, comprising:
a display module, for outputting a plurality of image control signals;
a retrieving module, coupled to the display module, for retrieving the plurality of image control signals and setting a preset offset value according to a coupling level of the plurality of image control signals;
a touch module, for outputting a plurality of driving signals; and
an adjusting module, coupled between the retrieving module and the touch module, for adjusting the plurality of driving signals according to the preset offset value.

2. The driving circuit of claim 1, wherein the plurality of image control signals comprises a plurality of common electrode signals, the retrieving module calculates a coupling offset related to the plurality of common electrode signals to set the preset offset value.

3. The driving circuit of claim 2, wherein the coupling offset is formed by the plurality of common electrode signals coupling with some of the plurality of image control signals other than the plurality of common electrode signals.

4. The driving circuit of claim 2, further comprising:
an operation module having a look-up table, wherein the look-up table comprises the relationship between the preset offset value and the plurality of common electrode signals, and the adjusting module adjusts the plurality of driving signals according to the look-up table.

5. The driving circuit of claim 2, wherein changes of the preset offset value and the coupling offset are inverted.

6. The driving circuit of claim 1, wherein the adjusting module superimposes the preset offset value to the plurality of driving signals in inverting phases to compensate the plurality of driving signals, and the touch module generates a plurality of sensing signals according to the compensated driving signals.

7. The driving circuit of claim 6, further comprising:
a touch panel, coupled to the display module and the touch module, for receiving the plurality of sensing signals from the touch module.

8. The driving circuit of claim 1, wherein each of the driving signals corresponds to a digital driving value respectively, and the digital driving values change with the compensated driving signals.

9. The driving circuit of claim 1, wherein the plurality of image control signals comprises a plurality of data electrode signals and a plurality of polarity control signals, and the plurality of data electrode signals are source electrode control signals.

10. The driving circuit of claim 1, wherein the adjusting module adjusts the plurality of driving signals according to the preset offset value, the plurality of driving signals is adjusted by an external voltage.
